(19) United States
(12) Patent Application Publication
(10) Pub. No.: US 2026/0119057 A1
(43) Pub. Date: Apr. 30, 2026

(54) STORAGE SYSTEM AND POWER CONTROL METHOD IN STORAGE SYSTEM

(71) Applicant: Hitachi Vantara, Ltd., Kanagawa-ken (JP)

(72) Inventors: Takumi OISHI, Tokyo (JP); Yoshihiro YOSHII, Tokyo (JP)

(21) Appl. No.: 19/327,759

(22) Filed: Sep. 12, 2025

(30) Foreign Application Priority Data
Oct. 30, 2024 (JP) 2024-190734

(51) Int. Cl. G06F 3/06

(52) U.S. Cl. CPC G06F 3/0625; G06F 3/0655; G06F 3/0679

(57) ABSTRACT

A storage system including a plurality of drives accessed in response to an I/O request from a host and a processor determines a normal drive whose power supply is turned on and a power saving target drive whose power supply is turned off among the plurality of drives on the basis of a data amount stored in the plurality of drives. The storage system moves all data stored in the power saving target drive to the normal drive, and turns off power supply to the power saving target drive after all data stored in the power saving target drive is moved to the normal drive.

### CROSS-REFERENCE TO PRIOR APPLICATION

This application relates to and claims the benefit of priority from Japanese Patent Application number 2024-190734, filed on Oct. 30, 2024 the entire disclosure of which is incorporated herein by reference.

### BACKGROUND OF THE INVENTION

### 1. Field of the Invention

The present invention relates to a storage system and a power control method in a storage system.

### 2. Description of the Related Art

In recent years, with the progress of IoT and AI, the data amount accumulated and utilized in a storage system has increased.

As a result, the storage system has a large capacity due to an increase in the number of mounted drives for storing data, such as SSDs and HDDs, and the power consumption amount increases. Therefore, an increase in power consumption and an increase in a burden of an electricity rate have become problems.

For example, JP 2013-210744 A discloses the following technology in order to reduce the power consumption of a storage system. That is, “The calculation unit calculates a first power consumption obtained by adding a power consumption of an unused first storage device to a total power consumption of a plurality of operating storage devices and a second power consumption obtained by adding a power consumption of an unused second storage device to the total power consumption of the plurality of operating storage devices and subtracting a power consumption of a storage device capable of moving data to the second storage device among the plurality of operating storage devices. The determination unit determines to activate the first storage device if the second power consumption is equal to or greater than the first power consumption, and determines to activate the second storage device if the second power consumption is not equal to or greater than the first power consumption”. (see paragraph 0007 of JP 2013-210744 A).

### SUMMARY OF THE INVENTION

However, the above-described conventional technique assumes that a plurality of drives are divided in advance into power-on operating drives and power-off unused drives, and the power consumption of the drives is merely reduced in a case where an unused drive is powered on and added to the operating drives. That is, the plurality of drives are not divided into drives to be powered on and drives to be powered off so as to reduce the power consumption of the drives.

The present invention has been made in view of the above circumstances, and an object of the present invention is to divide a plurality of drives into a drive to be powered on and a drive to be powered off so as to reduce the power consumption of the drives.

In order to achieve the above object, as one aspect, the present invention provides a storage system including: a plurality of drives accessed in response to an I/O request from a host; and a processor, wherein the processor determines a normal drive whose power supply is turned on and a power saving target drive whose power supply is turned off among the plurality of drives on the basis of a data amount stored in the plurality of drives, moves all data stored in the power saving target drive to the normal drive, and turns off power supply to the power saving target drive after all data stored in the power saving target drive is moved to the normal drive.

According to the present invention, for example, a plurality of drives can be divided into a drive to be powered on and a drive to be powered off so as to reduce the power consumption of the drives.

### BRIEF DESCRIPTION OF THE DRAWINGS

FIGS. 1A and 1B are explanatory diagrams of an outline of a first embodiment;

FIG. 2 is a diagram illustrating a configuration of a storage system according to the first embodiment;

FIG. 3 is a diagram illustrating a configuration of a drive information table according to the first embodiment;

FIG. 4 is a diagram illustrating a configuration of a device information table according to the first embodiment;

FIG. 5 is a diagram illustrating a configuration of a block information table according to the first embodiment;

FIG. 6 is a diagram illustrating a configuration of a RAID group information table according to the first embodiment;

FIG. 7 is a flowchart illustrating drive power-off processing according to the first embodiment;

FIG. 8 is a flowchart illustrating number-of-power saving target drives calculation processing according to the first embodiment;

FIG. 9 is a flowchart illustrating minimum number-of-component drives calculation processing according to the first embodiment;

FIG. 10 is a flowchart illustrating number-of-data storing drives calculation processing according to the first embodiment;

FIG. 11 is a flowchart illustrating performance limit check processing according to the first embodiment;

FIG. 12 is a flowchart illustrating number-of-unused drives calculation processing according to the first embodiment;

FIG. 13 is a flowchart illustrating drive group determination processing according to the first embodiment;

FIG. 14 is a flowchart illustrating candidate drive extraction processing according to the first embodiment;

FIG. 15 is a flowchart illustrating drive selection processing according to the first embodiment;

FIG. 16 is a flowchart illustrating inactive data access processing in a drive power-off state according to the first embodiment;

FIG. 17 is a flowchart illustrating inactive data additional storage processing according to the first embodiment;

FIG. 18 is a flowchart illustrating inactive data determination processing according to the first embodiment;

FIGS. 19A and 19B are explanatory diagrams of an outline of a second embodiment;

FIG. 20 is a diagram illustrating a configuration of a storage system according to the second embodiment;

FIG. 21 is a flowchart illustrating drive group determination processing according to the second embodiment;

FIG. 22 is a flowchart illustrating power saving drive box/accommodated drive determination processing according to the second embodiment;

FIG. 23 is a flowchart illustrating candidate drive extraction processing according to the second embodiment;

FIG. 24 is a flowchart illustrating drive selection processing according to the second embodiment;

FIG. 25 is a flowchart illustrating drive power-off processing according to a third embodiment; and

FIG. 26 is a flowchart illustrating drive power-off processing according to a fourth embodiment.

### DESCRIPTION OF THE PREFERRED EMBODIMENTS

In the following description, an “interface device” may be one or more communication interface devices. The one or more communication interface devices may be one or more communication interface devices of the same type (for example, one or more network interface cards (NICs)) or two or more communication interface devices of different types (for example, an NIC and a host bus adapter (HBA)).

In addition, in the following description, a “memory” is one or more memory devices as an example of one or more storage devices, and may typically be a main storage device. The at least one memory device in the memory may be a volatile memory device or a nonvolatile memory device.

In addition, in the following description, a “drive” is a persistent storage device. Typically, the persistent storage device may be a nonvolatile storage device (for example, an auxiliary storage device), and specifically, for example, may be a hard disk drive (HDD), a solid state drive (SSD), or a non-volatile memory express (NVMe) drive.

In addition, in the following description, a “processor” may be one or more processor devices. The at least one processor device may typically be a microprocessor device such as a central processing unit (CPU), but may be another type of processor device such as a graphics processing unit (GPU). The at least one processor device may be a single core or a multi-core. The at least one processor device may be a processor core. The at least one processor device may be a processor device in a broad sense, such as a hardware circuit that performs a part or all of processing (for example, a field-programmable gate array (FPGA), a complex programmable logic device (CPLD), or an application specific integrated circuit (ASIC)).

In addition, in the following description, processing may be described with a “program” as a subject. When executed by the processor, the program performs predetermined processing using the storage device and/or the interface device as appropriate. Therefore, the subject of the processing may be the processor (or a device such as a controller including the processor). The program may be installed in a device such as a computer from a program source. The program source may be, for example, a program distribution server or a computer-readable (for example, non-transitory) recording medium. In addition, in the following description, two or more programs may be implemented as one program, or one program may be implemented as two or more programs.

In addition, in the following description, information from which an output is obtained for an input may be described by an expression such as “xxx table”. However, the information may be data of any structure (for example, the information may be structured data or unstructured data), and may be a learning model that generates an output for an input, which is represented by a neural network, a genetic algorithm, or a random forest. Therefore, the “xxx table” can be referred to as “xxx information”. In addition, in the following description, the configuration of each table is an example, and one table may be divided into two or more tables, and all or a part of two or more tables may be one table.

### First Embodiment

### (Outline of First Embodiment)

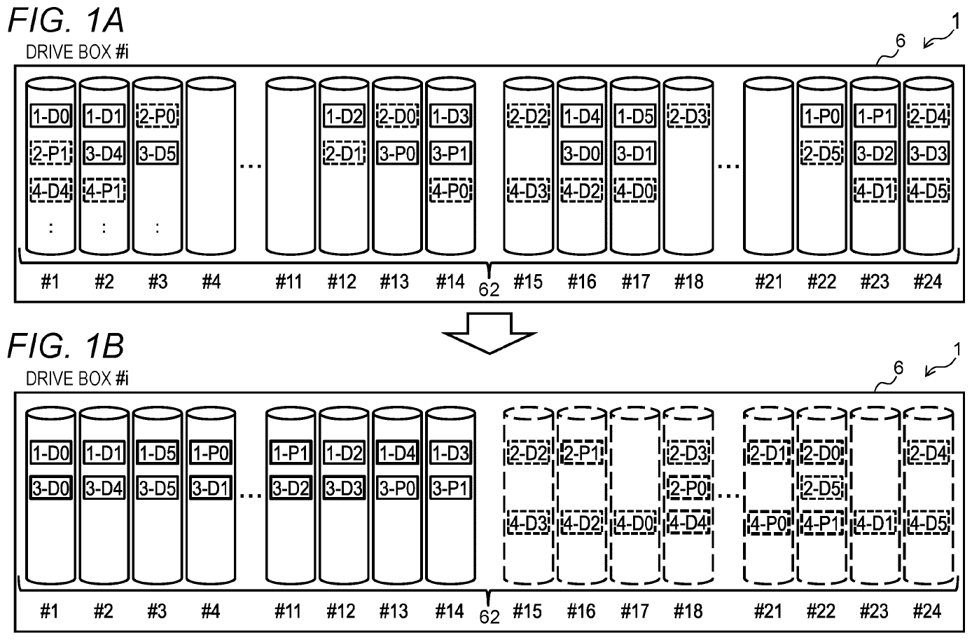

FIGS. 1A and 1B are explanatory diagrams of an outline of a first embodiment. A storage system 1 according to the first embodiment is a block storage. The storage system 1 includes one or more drive boxes 6 (#i (i=1, 2, . . . N (N is a natural number))). The drive boxes 6 (#i) are management units of drives 62, and each accommodates and manages N drives 62.

FIG. 1A illustrates data arrangement in the storage system 1 before active data is aggregated into normal drives and inactive data is aggregated into power saving target drives for each of the drive boxes 6. In FIG. 1A, the active data and the inactive data are distributed and arranged in all the normal drives. The storage system 1 adopts, for example, erasure coding having a 4D2P configuration in redundant arrays of inexpensive disks (RAID).

In FIGS. 1A and 1B, the normal drives are indicated by solid lines, and correspond to the drives 62 to be powered on or maintained powered on. The power saving target drives are indicated by broken lines, and correspond to the drives 62 to be powered off. The normal drives and the power saving target drives are set for each RAID group.

In addition, in FIGS. 1A and 1B, each piece of the active data is data stored in the drives 62 in which an access frequency based on an I/O request or the like from a host (not illustrated) is higher than a certain level, and is indicated by “1-D0” or the like surrounded by a solid rectangle. In addition, each piece of the inactive data is data stored in the drives 62 in which an access frequency based on an I/O request or the like from the host is equal to or lower than the certain level, and is indicated by “2-D1” or the like surrounded by a broken-line rectangle.

FIG. 1B illustrates data arrangement in the storage system 1 after the active data is aggregated into the normal drives and the inactive data is aggregated into the power saving target drives for each of the drive boxes 6. In FIG. 1B, the active data is stored in the normal drives, and the inactive data is aggregated and arranged in the power saving target drives. Here, active data moved from a power saving target drive to a normal drive is indicated by “3-D0” or the like surrounded by a thick solid line rectangle, and inactive data moved from a normal drive to a power saving target drive is indicated by “2-P1” or the like surrounded by a thick broken-line rectangle.

### (Storage System 1 According to First Embodiment)

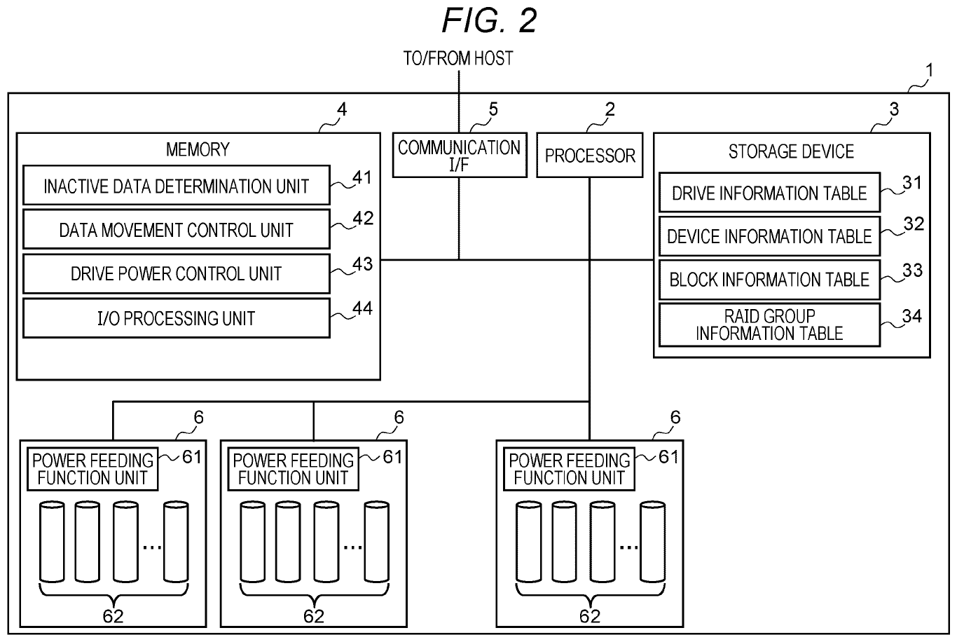

FIG. 2 is a diagram illustrating a configuration of the storage system 1 according to the first embodiment. The storage system 1 includes a processor 2, a storage device 3, a memory 4, a communication I/F 5, and one or more drive boxes 6.

The processor 2 executes overall control of the storage system 1, processes an I/O request from the host (not illustrated), and executes reading and writing of data stored in one or more drives 62 stored in each of the drive boxes 6.

The storage device 3 is a nonvolatile storage device that stores a drive information table 31, a device information table 32, a block information table 33, and a RAID group information table 34.

The memory 4 includes an inactive data determination unit 41, a data movement control unit 42, a drive power control unit 43, and an I/O processing unit 44. The inactive data determination unit 41, the data movement control unit 42, the drive power control unit 43, and the I/O processing unit 44 are functional units implemented by the processor 2 executing a program read from a storage area such as the storage device 3.

Each of the drive boxes 6 includes a power feeding function unit 61 and one or more drives 62. The power feeding function unit 61 supplies power to the drives 62, and turns on and off power supply to the drives 62 in response to an instruction from the processor 2. Each of the drives 62 is a nonvolatile storage device such as a hard disk drive (HDD) or a solid state drive (SSD).

### (Drive Information Table 31 According to First Embodiment)

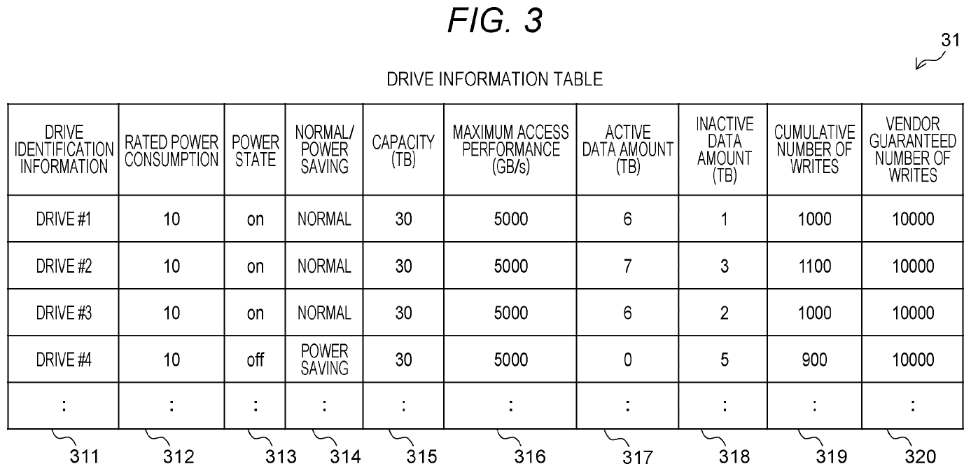

FIG. 3 is a diagram illustrating a configuration of the drive information table 31 according to the first embodiment. The drive information table 31 includes items of drive identification information 311, rated power consumption 312, a power state 313, normal/power saving 314, a capacity 315, maximum access performance 316, an active data amount 317, and an inactive data amount 318. The drive information table 31 further includes items of a cumulative number of writes 319 and a vendor guaranteed number of writes 320.

The drive identification information 311 is identification information for identifying each of the drives 62 across the drive boxes 6. The rated power consumption 312 indicates the rated power consumption of the drive 62 identified by the drive identification information 311. The power state 313 indicates on and off states of the power, that is, the power supply of the drive 62 identified by the drive identification information 311. In the normal/power saving 314, “normal” indicates that the drive 62 identified by the drive identification information 311 is a normal drive, and “power saving” indicates that the drive 62 is a power saving target drive. The capacity 315 indicates the total capacity of the storage area of the drive 62 identified by the drive identification information 311. The maximum access performance 316 indicates the maximum value of the throughput in the specifications of the drive 62 identified by the drive identification information 311.

The active data amount 317 indicates the total volume of the active data stored in the drive 62 identified by the drive identification information 311. The inactive data amount 318 indicates the total volume of the inactive data stored in the drive 62 identified by the drive identification information 311. The cumulative number of writes 319 indicates the cumulative number of writes of data to the drive 62 identified by the drive identification information 311 since the start of operation of the drive 62. The vendor guaranteed number of writes 320 is the guaranteed value of the number of writes in the specifications of the drive 62 identified by the drive identification information 311.

### (Device Information Table 32 According to First Embodiment)

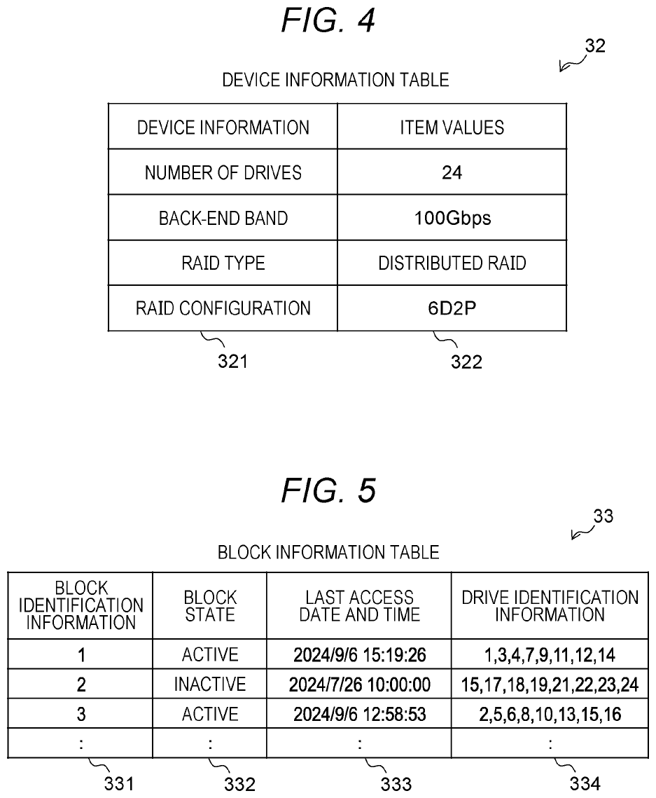

FIG. 4 is a diagram illustrating a configuration of the device information table 32 according to the first embodiment. The device information table 32 stores device information related to each of the drive boxes 6. The device information table 32 includes device information 321 and item values 322. The device information 321 is an information item related to the specifications of the drive box 6, and includes, for example, “number of drives”, “back-end band”, “RAID type”, “RAID configuration”, and the like. The “number of drives” is the total number of drives 62 stored in the drive box 6. The “back-end band” is the maximum value of the communication throughput between the drives 62 of the drive box 6. The “RAID type” indicates the type of RAID adopted in the storage system 1. The “RAID configuration” indicates the configuration of RAID adopted in the storage system 1.

### (Block Information Table 33 According to First Embodiment)

FIG. 5 is a diagram illustrating a configuration of the block information table 33 according to the first embodiment. The block information table 33 includes items of block identification information 331, a block state 332, a last access date and time 333, and drive identification information 334.

The block identification information 331 is identification information of each block, which is a storage area of the drives 62. In the block state 332, “active” indicates that the data stored in the block identified by the block identification information 331 and the drive identification information 334 is active data, and “inactive” indicates that the data is inactive data. The last access date and time 333 is the date and time when the block identified by the block identification information 331 and the drive identification information 334 was last accessed on the basis of an I/O request or the like from the host. The drive identification information 334 is identification information of drives in which the block identified by the block identification information 331 is stored (the drive identification information 311 of the drive information table 31).

### (RAID Group Information Table 34 According to First Embodiment)

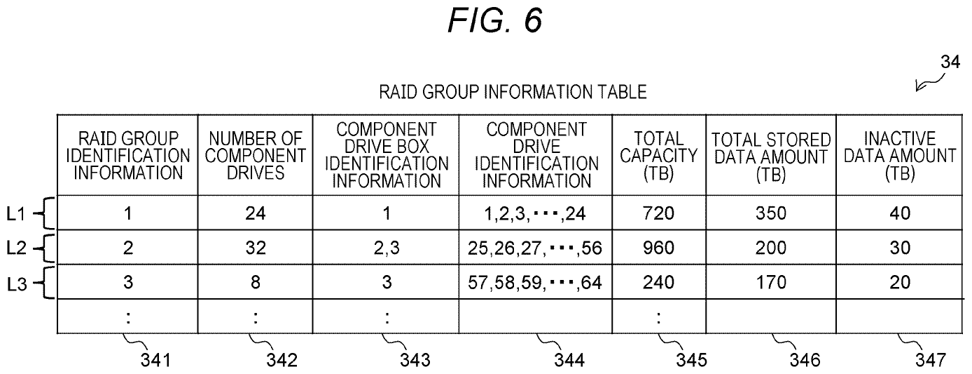

FIG. 6 is a diagram illustrating a configuration of the RAID group information table 34 according to the first embodiment. The RAID group information table 34 includes items of RAID group identification information 341, the number of component drives 342, component drive box identification information 343, component drive identification information 344, a total capacity 345, a total stored data amount 346, and an inactive data amount 347.

The RAID group identification information 341 is identification information of a RAID group. The number of component drives 342 is the number of drives 62 belonging to the RAID group identified by the RAID group identification information 341. The component drive box identification information 343 is identification information of the drive box 6 in which the drives 62 belonging to the RAID group identified by the RAID group identification information 341 are accommodated. The component drive identification information 344 is identification information of the drives 62 belonging to the RAID group identified by the RAID group identification information 341. The total capacity 345 is the total capacity of the storage area of the RAID group identified by the RAID group identification information 341. The total stored data amount 346 is the data amount stored in the storage area of the RAID group identified by the RAID group identification information 341. The inactive data amount 347 is the total volume of the inactive data stored in the storage area of the RAID group identified by the RAID group identification information 341.

In the first embodiment, for a RAID group set in one drive box 6, active data is aggregated into normal drives, and inactive data is aggregated into power saving target drives. Therefore, in the first embodiment, as illustrated in rows L1 and L3 of the RAID group information table 34, a RAID group configured by one drive box 6 is a processing target. In the first embodiment, as illustrated in a row L2 of the RAID group information table 34, a RAID group configured by a plurality of drive boxes 6 is not a processing target.

### (Drive Power-Off Processing According to First Embodiment)

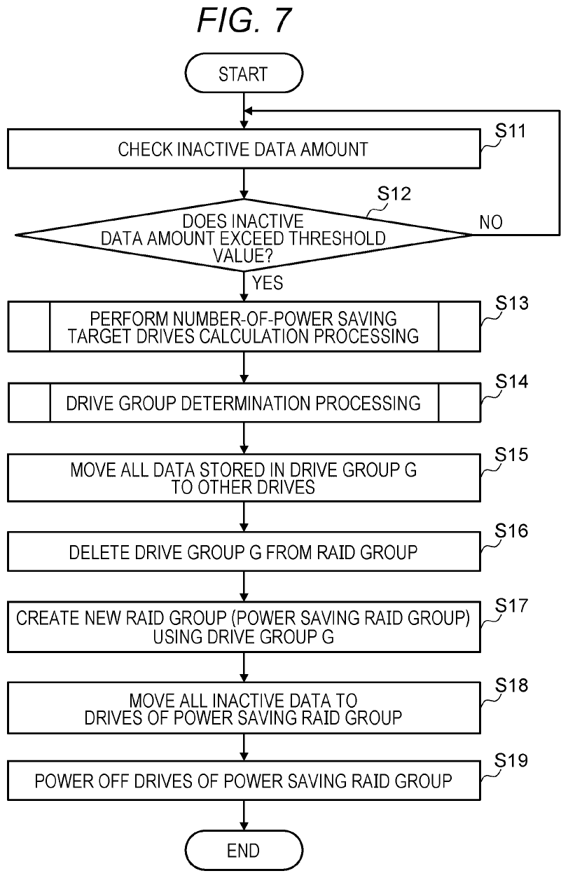

FIG. 7 is a flowchart illustrating drive power-off processing according to the first embodiment. The drive power-off processing is periodically executed by the drive power control unit 43 in units of drive boxes 6.

First, in step S11, the drive power control unit 43 refers to the RAID group information table 34, and checks the item value of the inactive data amount 347 of a RAID group in the processing target drive box 6.

Next, in step S12, the drive power control unit 43 determines whether the total value of the inactive data amount 347 of the RAID group in the processing target drive box 6 checked in step S11 exceeds a threshold value. If the total value of the inactive data amount 347 exceeds the threshold value (YES in step S12), the drive power control unit 43 shifts the processing to step S13, and if the total value is equal to or lower than the threshold value (NO in step S12), the drive power control unit 43 returns the processing to step S11.

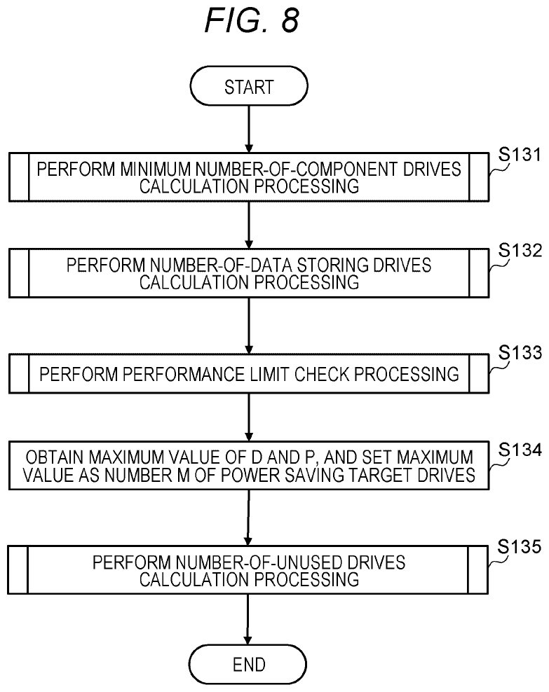

Next, in step S13, the drive power control unit 43 executes number-of-power saving target drives calculation processing of calculating a number M of power saving target drives in the processing target drive box 6. Details of the number-of-power saving target drives calculation processing will be described later with reference to FIG. 8.

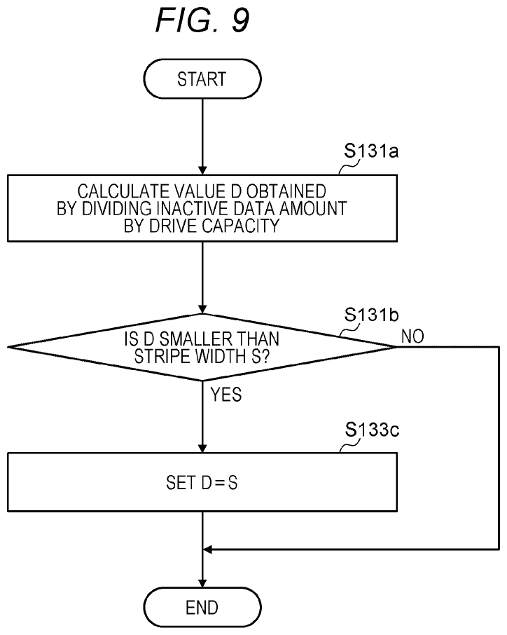

Next, in step S14, the drive power control unit 43 executes drive group determination processing of selecting drives 62 corresponding to the number M calculated in step S13 in the processing target drive box 6 and determining a drive group G. Details of the drive group determination processing will be described later with reference to FIG. 9.

Next, in step S15, the drive power control unit 43 controls the data movement control unit 42 to move all the data stored in the drives 62 of the drive group G to the drives 62 other than the drive group G in the processing target drive box 6.

Next, in step S16, the drive power control unit 43 deletes the drives 62 of the drive group G from the corresponding RAID group in the RAID group information table 34. Next, in step S17, the drive power control unit 43 creates a new RAID group (power saving RAID group) using the drive group G, and adds the information to the RAID group information table 34.

Next, in step S18, the drive power control unit 43 controls the data movement control unit 42 to move all the inactive data to the drives 62 of the power saving RAID group created in step S17 in the processing target drive box 6.

Next, in step S19, the drive power control unit 43 turns off all the power of the drives 62 of the power saving RAID group created in step S17. At this time, in the drive information table 31 (FIG. 3), the drive power control unit 43 sets the power state 313 of each of the drives 62 whose power has been turned off to “off”, and sets the normal/power saving 314 to “power saving”.

### (Number-of-Power Saving Target Drives Calculation Processing According to First Embodiment)

FIG. 8 is a flowchart illustrating the number-of-power saving target drives calculation processing (step S13 (FIG. 7)) according to the first embodiment.

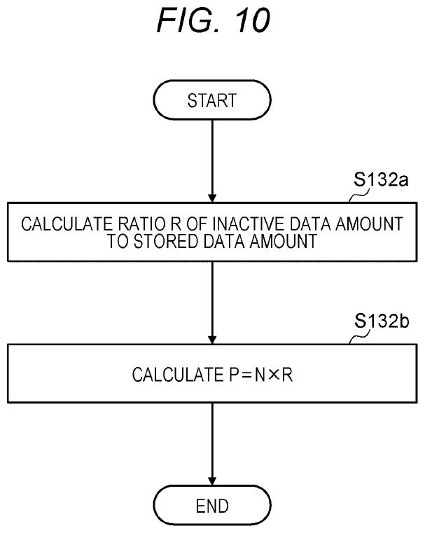

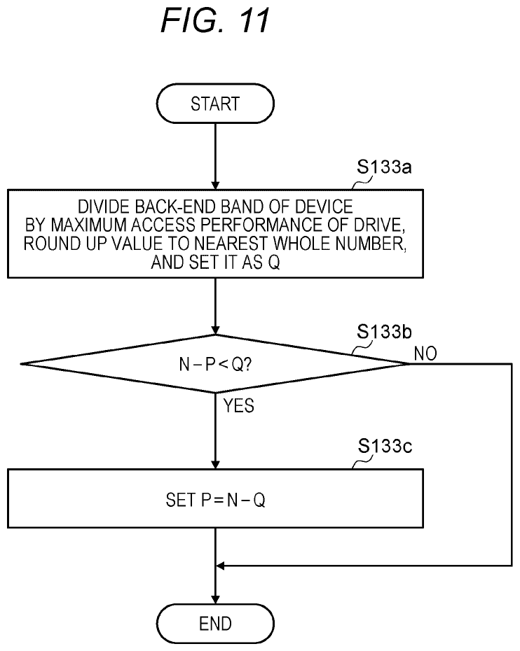

First, in step S131, the drive power control unit 43 executes minimum number-of-component drives calculation processing. Details of the minimum number-of-component drives calculation processing will be described later with reference to FIG. 9. Next, in step S132, the drive power control unit 43 executes number-of-data storing drives calculation processing. Details of the number-of-data storing drives calculation processing will be described later with reference to FIG. 10. Next, in step S133, the drive power control unit 43 executes performance limit check processing. Details of the performance limit check processing will be described later with reference to FIG. 11.

Next, in step S134, the drive power control unit 43 compares a minimum number D of component drives calculated in step S131 with a number P of data storing drives calculated in step S132, and obtains the maximum value thereof as the number M of power saving target drives.

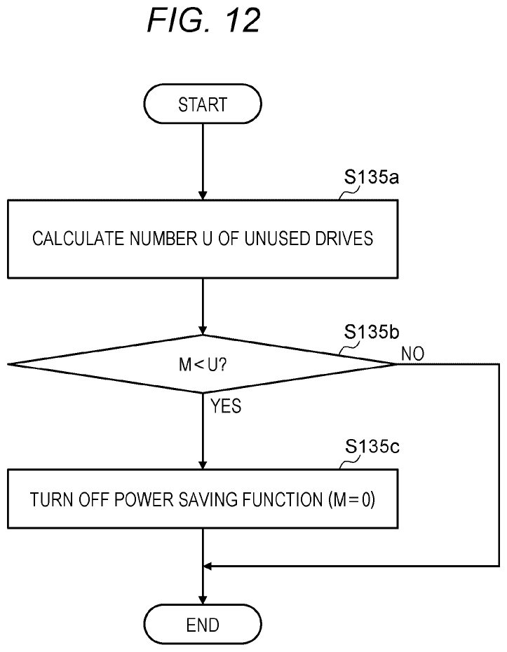

Next, in step S135, the drive power control unit 43 executes number-of-unused drives calculation processing. Details of the number-of-unused drives calculation processing will be described later with reference to FIG. 12.

### (Minimum Number-of-Component Drives Calculation Processing According to First Embodiment)

FIG. 9 is a flowchart illustrating the minimum number-of-component drives calculation processing (step S131 (FIG. 8)) according to the first embodiment.

First, in step S131a, the drive power control unit 43 obtains a value D (rounded up to the nearest whole number) obtained by dividing the inactive data amount calculated in step S11 (FIG. 7) by the drive capacity (total capacity) of the corresponding RAID group.

Next, in step S131b, the drive power control unit 43 determines whether the value D calculated in step S131a is smaller than a stripe width S of the corresponding RAID group. If the value D is smaller than the stripe width S (YES in step S131a), the drive power control unit 43 shifts the processing to step S133c, and if the value D is equal to or larger than the stripe width S (NO in step S131a), the minimum number-of-component drives calculation processing ends. In step S133c, the drive power control unit 43 sets D=S.

### (Number-of-Data Storing Drives Calculation Processing According to First Embodiment)

FIG. 10 is a flowchart illustrating the number-of-data storing drives calculation processing (step S132 (FIG. 8)) according to the first embodiment.

In step S132a, the drive power control unit 43 refers to the RAID group information table 34, and calculates a ratio R of the total value of the inactive data amount (step S11 (FIG. 7)) to the stored data amount of the RAID group in the processing target drive box 6.

Next, in step S132b, the drive power control unit 43 calculates P=N×R (where N is the total number of the drives 62 in the processing target drive box 6), and executes rounding up of P (rounding up P to the nearest whole number).

### (Performance Limit Check Processing According to First Embodiment)

FIG. 11 is a flowchart illustrating the performance limit check processing (step S133 (FIG. 8)) according to the first embodiment. The performance limit check processing is to determine the number of power saving target drives in order to prevent the write throughput from decreasing in a case where the number of normal drives is smaller than a certain number.

First, in step S133a, the drive power control unit 43 sets a value obtained by dividing the back-end band of the storage system 1 by the maximum value of the maximum access performances 316 of the drives 62 in the processing target drive box 6 as Q (rounded up to the nearest whole number).

Next, in step S133b, the drive power control unit 43 determines whether N−P<Q holds for the total number N of the drives 62 in the processing target drive box 6, P calculated in step S132 (FIG. 8), and Q calculated in step S133a. If N−P<Q holds (YES in step S133b), the drive power control unit 43 shifts the processing to step S133c, and if N−P≥Q holds (NO in step S133b), the performance limit check processing ends. In step S133c, the drive power control unit 43 sets P=N−Q.

### (Number-of-Unused Drives Calculation Processing According to First Embodiment)

FIG. 12 is a flowchart illustrating the number-of-unused drives calculation processing (step S135 (FIG. 8)) according to the first embodiment. The number-of-unused drives calculation processing is to cancel the selection of the power saving target drives and stop the power saving function in a case where a sufficient number of drives 62 are already unused and powered off.

First, in step S135a, the drive power control unit 43 calculates a number U of unused drives. That is, for the processing target drive box 6, the number U of unused drives (for example, rounded down to the nearest whole number) is calculated on the basis of Formula (1). In Formula (1), “a” is the number of drives of the device information table 32, “b” is the item value of the total stored data amount 346 of the RAID group information table 34, and “c” is the item value of the capacity 315 of the drive information table 31. That is, U is “the number of unused drives 62 in which no data is stored, which can be calculated on the basis of the total stored data amount”.

$$U = a - ( b / c ) \qquad ( 1 )$$

Next, in step S135b, the drive power control unit 43 determines whether M<U holds for the number M of power saving target drives determined in step S134 (FIG. 8). If M<U holds (YES in step S135b), the drive power control unit 43 shifts the processing to step S135c, and if M≥U holds (NO in step S135b), the number-of-unused drives calculation processing ends. In step S135c, the drive power control unit 43 turns off the power saving function (the number M of power saving target drives=0).

When the power saving function is turned off, the following four types of processing are canceled. That is, the four types of processing includes the processing of determining the power saving target drives (step S14 (FIG. 7)), the processing of moving all the data stored in the power saving target drives to the normal drives (step S15 (FIG. 7)), the processing of moving all the inactive data stored in the normal drives to the power saving target drives (step S18 (FIG. 7)), and the processing of turning off power supply to the power saving target drives (step S19 (FIG. 7)).

### (Drive Group Determination Processing According to First Embodiment)

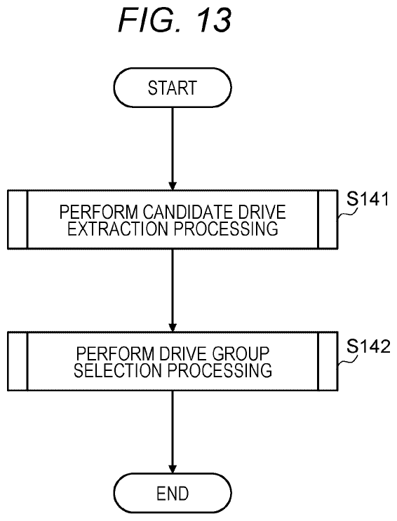

FIG. 13 is a flowchart illustrating the drive group determination processing (step S14 (FIG. 7)) according to the first embodiment.

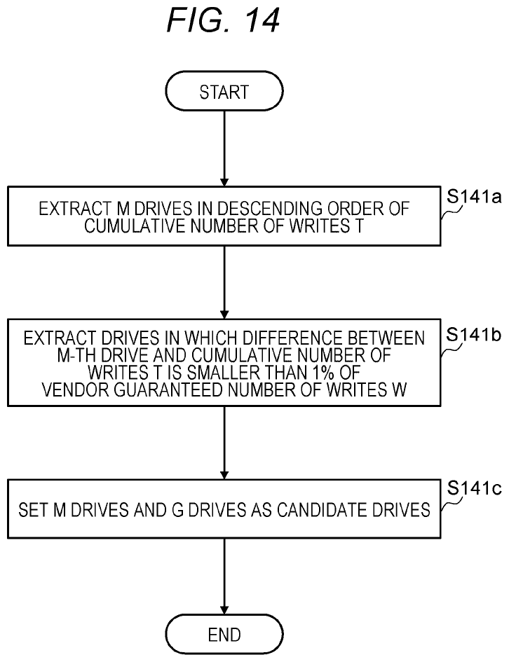

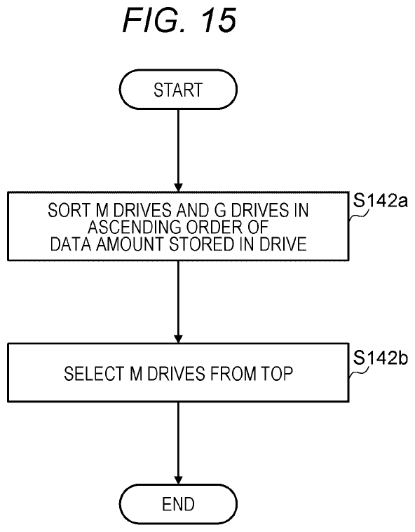

First, in step S141, the drive power control unit 43 executes candidate drive extraction processing. Details of the candidate drive extraction processing will be described later with reference to FIG. 14. Next, in step S142, the drive power control unit 43 executes drive group selection processing. Details of the drive group selection processing will be described later with reference to FIG. 15.

### (Candidate Drive Extraction Processing According to First Embodiment)

FIG. 14 is a flowchart illustrating the candidate drive extraction processing (step S141 (FIG. 13)) according to the first embodiment. The candidate drive extraction processing is to set drives 62 each having a small remaining number of writes as power saving target drives to be stopped with inactive data stored, which levels the lives of the drives and enables the drives to be replaced at the same timing, so that the maintenance cost is reduced.

First, in step S141a, for the processing target drive box 6, the drive power control unit 43 extracts M drives 62 (the drive identification information 311) in descending order of a cumulative number-of-writes value T of the cumulative number of writes 319 (the drive information table 31 (FIG. 3)).

Next, in step S141b, the drive power control unit 43 extracts drives 62 (the drive identification information 311) meeting a predetermined condition separately from the M drives 62. The predetermined condition is a condition that a difference between the minimum value of the cumulative number-of-writes values T of the M drives 62 extracted in step S141a and the cumulative number-of-writes value T is less than a predetermined % (1% or the like) of a vendor guaranteed number-of-writes value W of the vendor guaranteed number of writes 320 (FIG. 3). Here, it is assumed that G drives 62 are extracted.

Next, in step S141c, the drive power control unit 43 sets the M drives 62 extracted in step S141a and the G drives 62 extracted in step S141b as candidate drives.

### (Drive Selection Processing According to First Embodiment)

FIG. 15 is a flowchart illustrating the drive selection processing (step S142 (FIG. 13)) according to the first embodiment. The drive selection processing is to select drives having as small stored data amounts as possible in order to shorten a processing time of data movement when the stored data is moved from the power saving target drives to the normal drives and to reduce the number of writes to the drives.

First, in step S142a, the drive power control unit 43 sorts the M+G drives 62 extracted in step S141 (FIG. 13) in ascending order of the active data amount+the inactive data amount on the basis of the drive information table 31.

Next, in step S142b, the drive power control unit 43 selects M drives 62 in ascending order of the active data amount+the inactive data amount from the drives 62 sorted in step S142a. Here, the selected M drives 62 are defined as the drive group G.

### (Inactive Data Access Processing in Drive Power-Off State According to First Embodiment)

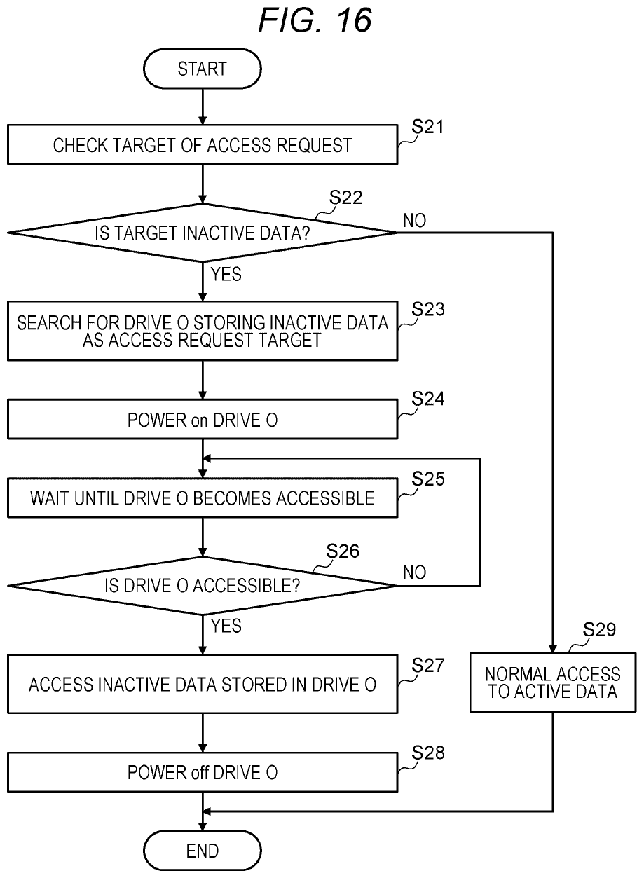

FIG. 16 is a flowchart illustrating inactive data access processing in a drive power-off state according to the first embodiment. The inactive data access processing in a drive power-off state is executed when inactive data stored in a drive 62 whose power is turned off by the drive power-off processing (FIG. 7) is requested to be accessed on the basis of an I/O request or the like from the host (not illustrated).

First, in step S21, the I/O processing unit 44 checks block identification information of target data of the access request. Next, in step S22, the I/O processing unit 44 determines whether the data whose block identification information has been checked in step S21 is inactive data. If the data is inactive data (YES in step S22), the I/O processing unit 44 shifts the processing to step S23, and if the data is active data (NO in step S22), the I/O processing unit 44 shifts the processing to step S29.

In step S23, the I/O processing unit 44 searches for a drive O storing the inactive data as the access request target. Next, in step S24, the I/O processing unit 44 controls the drive power control unit 43 to turn on the power of the drive O searched for in step S23. Next, in step S25, the I/O processing unit 44 waits until the drive O becomes accessible.

Next, in step S26, the I/O processing unit 44 determines whether the drive O is accessible. The I/O processing unit 44 refers to the power state 313 of the drive information table 31, and determines whether the drive O is accessible (powered on). If the drive O is accessible (YES in step S26), the I/O processing unit 44 shifts the processing to step S27, and if the drive O is not accessible (NO in step S26), the I/O processing unit 44 returns the processing to step S25.

In step S27, the I/O processing unit 44 accesses the inactive data stored in the drive O. Next, in step S28, the I/O processing unit 44 controls the drive power control unit 43 to turn off the power of the drive O after the access to the drive O ends.

Meanwhile, in step S29, the I/O processing unit 44 executes normal access to the data determined as active data in step S22.

### (Inactive Data Additional Storage Processing According to First Embodiment)

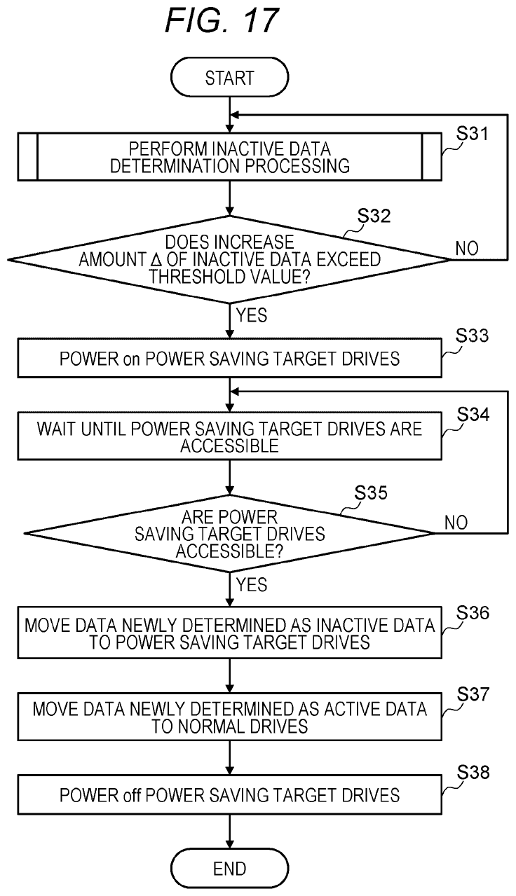

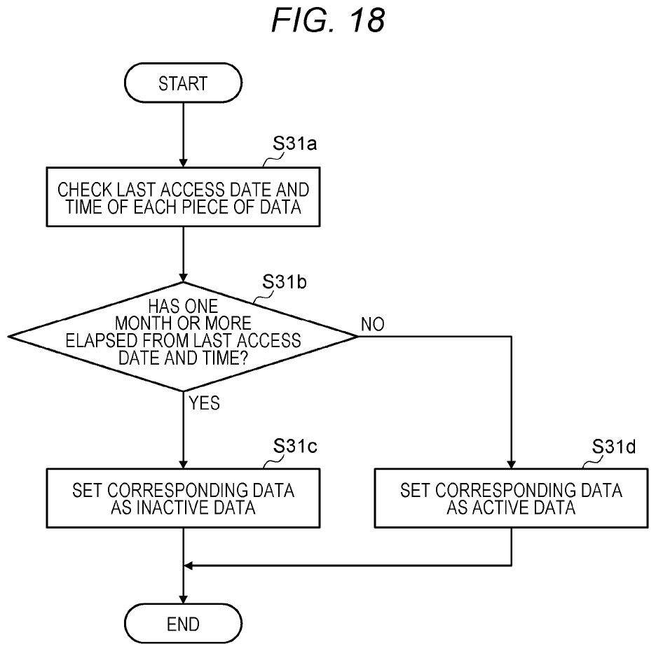

FIG. 17 is a flowchart illustrating inactive data additional storage processing according to the first embodiment. The inactive data additional storage processing is executed at a predetermined cycle after the drives 62 are powered off by the drive power-off processing (FIG. 7).

First, in step S31, the inactive data determination unit 41 executes inactive data determination processing. Details of the inactive data determination processing will be described later with reference to FIG. 18. Next, in step S32, the inactive data determination unit 41 determines whether an increase amount Δ of the data amount determined as inactive data in step S31 relative to the data amount at the previous determination exceeds a threshold value. If the increase amount Δ exceeds the threshold value (YES in step S32), the inactive data determination unit 41 shifts the processing to step S33, and if the increase amount Δ does not exceed the threshold value (NO in step S32), the inactive data determination unit 41 returns the processing to step S31.

In step S33, the inactive data determination unit 41 refers to the drive information table 31 (FIG. 3), and turns on the power of all the power saving target drives that are currently turned off. Next, in step S34, the inactive data determination unit 41 waits until the power saving target drives powered on in step S33 become accessible.

Next, in step S35, the inactive data determination unit 41 refers to the power state 313 of the drive information table 31, and determines whether the power saving target drives are accessible (powered on). If the power saving target drives are accessible (YES in step S35), the inactive data determination unit 41 shifts the processing to step S36, and if the power saving target drives are not accessible (NO in step S35), the inactive data determination unit 41 returns the processing to step S34.

In step S36, the inactive data determination unit 41 controls the data movement control unit 42 to move the data newly determined as inactive data in step S31 to the power saving target drives. Next, in step S37, the inactive data determination unit 41 controls the data movement control unit 42 to move the data newly determined as active data in step S31 to the normal drives. Next, in step S38, the inactive data determination unit 41 controls the drive power control unit 43 to turn off the power of the power saving target drives.

### (Inactive Data Determination Processing According to First Embodiment)

FIG. 18 is a flowchart illustrating the inactive data determination processing (step S31 (FIG. 17)) according to the first embodiment. The inactive data determination processing is executed for all the data in which the last access date and time 333 is recorded in the block information table 33.

First, in step S31a, the inactive data determination unit 41 refers to the block information table 33, and checks the last access date and time 333 of each block (the block identification information 331). Next, in step S31b, the inactive data determination unit 41 determines whether a predetermined period (for example, one month) or more has elapsed from the last access date and time 333 to the current date and time (whether the access frequency is equal to or higher than a certain level or lower than the certain level). If the predetermined period or more has elapsed from the last access date and time 333 to the current date and time (YES in step S31b), the inactive data determination unit 41 moves the processing to step S31c, and if less than the predetermined period has elapsed (NO in step S31b), the inactive data determination unit 41 moves the processing to step S31d.

In step S31c, the inactive data determination unit 41 sets the data for which it is determined in step S31b that the predetermined period or more has elapsed from the last access date and time 333 to the current date and time as inactive data, and updates the corresponding record in the block information table 33. On the other hand, in step S31d, the inactive data determination unit 41 sets the data for which it is determined in step S31b that less than the predetermined period has elapsed from the last access date and time 333 to the current date and time as active data, and updates the corresponding record in the block information table 33.

### (First Modification of First Embodiment)

In the first embodiment, the inactive data is aggregated into the power saving target drives in units of drives 62 in a single RAID group. However, the first embodiment can also be applied even in a case where the inactive data is aggregated into a certain RAID group in units of RAID groups in the storage system 1 and the data amount of the inactive data exceeds the capacity of the RAID group as an aggregation destination.

That is, in a case where the total value of all the inactive data amounts 347 (FIG. 6) stored in the drives 62 constituting a plurality of RAID groups of the storage system 1 exceeds the total capacity 345 (FIG. 6) of the RAID group as the aggregation destination, the processing is performed as follows. A RAID group is newly created by drives 62 that can store all the inactive data stored in the storage system 1, and the drives 62 constituting the RAID group are set as power saving target drives. All the active data is aggregated into the normal drives, all the inactive data is aggregated into the power saving target drives, and the power of the power saving target drives is turned off. In this way, all the inactive data is aggregated into the power saving target drives among the plurality of RAID groups, so that it is possible to reduce the power of the power saving target drives.

### (Second Modification of First Embodiment)

In the first embodiment, the plurality of drives 62 accommodated in the drive box 6 are set as processing targets, and the inactive data is aggregated into the power saving target drives. However, the present invention is not limited thereto, and the plurality of drives 62 may be set as processing targets and the inactive data may be aggregated into the power saving target drives regardless of whether the drives 62 are accommodated in the drive box 6 or whether the drives 62 constitute a RAID group.

### (Effects of First Embodiment)

In the first embodiment, a normal drive and a power saving target drive are determined on the basis of the data amount of inactive data stored in a plurality of drives. All the data stored in the power saving target drive is moved to the normal drive, and then all the inactive data stored in the normal drive is moved to the power saving target drive. Thereafter, power supply to the power saving target drive is turned off. Therefore, even in a case where all of the active data+the inactive data cannot be aggregated into the power saving target drive, the inactive data having a low probability of being accessed is aggregated into the power saving target drive, and the power saving target drive is powered off, whereby the power saving effect is efficiently achieved.

In addition, in the first embodiment, the power saving target drive is selected from the plurality of drives on the basis of write performances of the drives. Therefore, it is possible to prevent an inconvenience that the number of component drives of a RAID group in power saving target drives is small and the write throughput decreases.

In addition, in the first embodiment, the power saving target drive is selected from the plurality of drives on the basis of the life of each drive based on the actual number of writes of each drive and the number of writable times in the product specifications. Therefore, the remaining lives of the drives are leveled by a drive with a small remaining number of writes being used for storing inactive data with a low access frequency, and the timing of replacement due to the life of each drive is made the same, so that it is possible to reduce the maintenance cost.

In addition, in the first embodiment, the power saving target drive is selected from the plurality of drives in ascending order of the data amount of the inactive data stored in each drive. When the storage power reduction function is enabled, it is necessary to move stored data from the power saving target drive to the normal drive. Selecting a drive having a small stored data amount as the power saving target drive makes it possible to shorten the time required for the processing of moving the stored data and to reduce the number of writes to the drive, which enables the drive life to be extended.

In addition, in the first embodiment, in a case where an I/O request from the host is made for the inactive data stored in the power saving target drive whose power supply is turned off, power supply to the power saving target drive is turned on. After power supply to the power saving target drive is turned on, the inactive data is accessed, and when the access to the inactive data ends, power supply to the power saving target drive is turned off. Therefore, even in a case where an I/O request for the inactive data stored in the power saving target drive is made, the I/O processing can be performed.

In addition, in the first embodiment, it is determined whether each piece of data stored in the plurality of drives is active data or inactive data at a predetermined cycle. Furthermore, it is determined whether the increase amount of the inactive data determined this time relative to the inactive data determined last time exceeds a threshold value. In a case where the increase amount exceeds the threshold value, power supply to the power saving target drive is turned on, and the inactive data corresponding to the increase amount is moved from the normal drive to the power saving target drive after power supply to the power saving target drive is turned on.

After the inactive data corresponding to the increase amount is moved from the normal drive to the power saving target drive, power supply to the power saving target drive is turned off. Therefore, even if the inactive data increases with the lapse of time, it is possible to appropriately move the inactive data to the power saving target drive and efficiently use the capacity of the normal drive.

In addition, in the first embodiment, the number of drives of the power saving target drive is compared with the number of unused drives in which no data is stored and that are powered off. In a case where the number of drives is smaller than the number of unused drives, the processing of determining the power saving target drive and the processing of moving all the data stored in the power saving target drive to the normal drive are canceled. Furthermore, the processing of moving all the inactive data stored in the normal drive to the power saving target drive and the processing of turning off power supply to the power saving target drive are canceled. Therefore, the storage power reduction function is caused to function under the condition that the storage power reduction function exhibits the effect, and the storage power reduction function is disabled and unnecessary processing can be omitted under the condition that the effect is not exhibited.

### Second Embodiment

In the first embodiment, for a RAID group set in one drive box 6, the active data is aggregated into the normal drives and the inactive data is aggregated into the power saving target drives for each of the drive boxes 6, and the power of the power saving target drives is turned off. On the other hand, in a second embodiment, for a RAID group extending across a plurality of drive boxes 6, the active data is aggregated into the normal drives and the inactive data is aggregated into the power saving target drives across the drive boxes 6. The power of the power saving target drives is then turned off. In the following description of the second embodiment, differences from the first embodiment will be mainly described.

In the second embodiment, as illustrated in the row L2 of the RAID group information table 34 (FIG. 6), a RAID group configured by a plurality of drive boxes 6 is set as a processing target.

### (Outline of Second Embodiment)

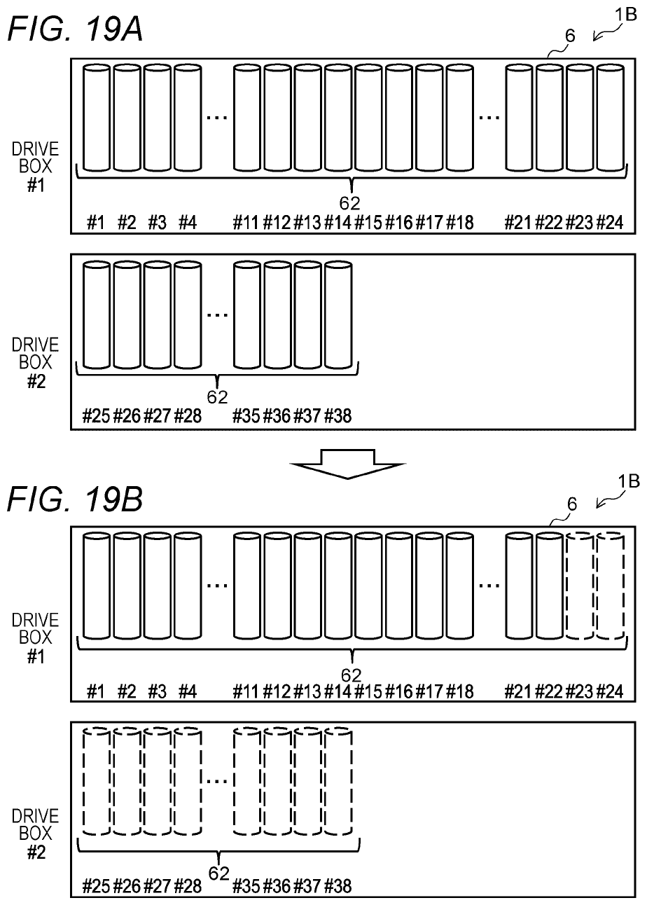

FIGS. 19A and 19B are explanatory diagrams of an outline of the second embodiment. In FIGS. 19A and 19B, the normal drives are indicated by solid lines, and correspond to the drives 62 to be powered on or maintained powered on. The power saving target drives are indicated by broken lines, and correspond to the drives 62 to be powered off.

FIG. 19A illustrates data arrangement in a storage system 1B before the active data is aggregated into the normal drives and the inactive data is aggregated into the power saving target drives for a RAID group set in the drive boxes 6 (#1 and #2). In FIG. 19A, the active data and the inactive data are distributed and arranged in all the normal drives of the drive boxes 6 (#1 and #2).

FIG. 19B illustrates data arrangement in the storage system 1B after the active data is aggregated into the normal drives and the inactive data is aggregated into the power saving target drives across the drive boxes 6 (#1 and #2). In FIG. 19B, the active data is stored in the normal drives of the drives 62 (drives 62 (#1 to #22)) of the drive box 6 (#1). The inactive data is aggregated into the power saving target drives (drives 62 (#23 and #24)) of the drive box 6 (#1) and the power saving target drives (drives 62 (#25 to #38)) of the drive box 6 (#2).

### (Storage System 1B According to Second Embodiment)

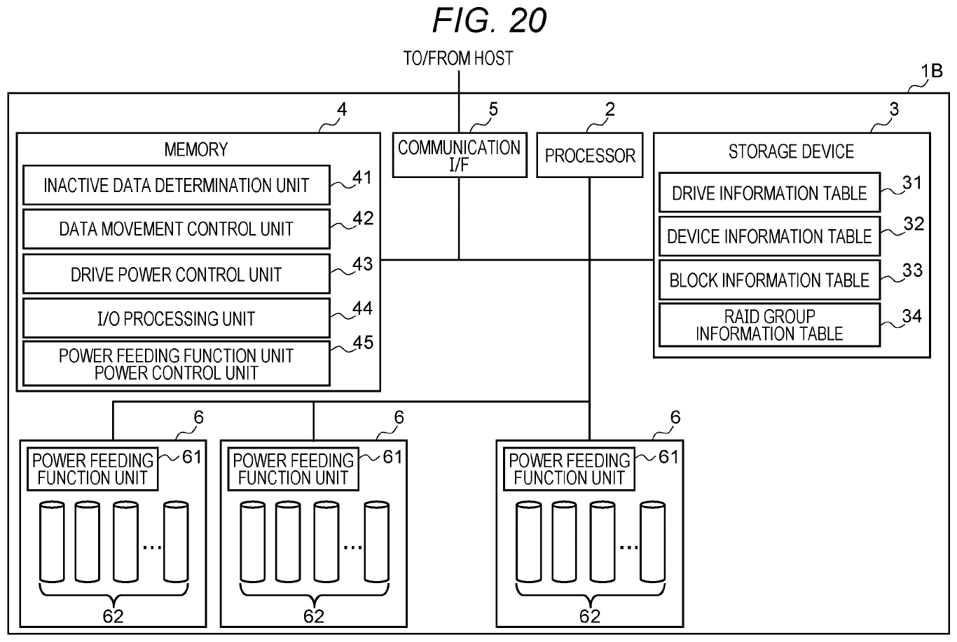

FIG. 20 is a diagram illustrating a configuration of the storage system 1B according to the second embodiment. The storage system 1B further includes a power feeding function unit power control unit 45 in the memory 4 as compared with the storage system 1 according to the first embodiment. The power feeding function unit power control unit 45 controls on/off of the power of the power feeding function units 61 included in the drive boxes 6.

### (Drive Group Determination Processing According to Second Embodiment)

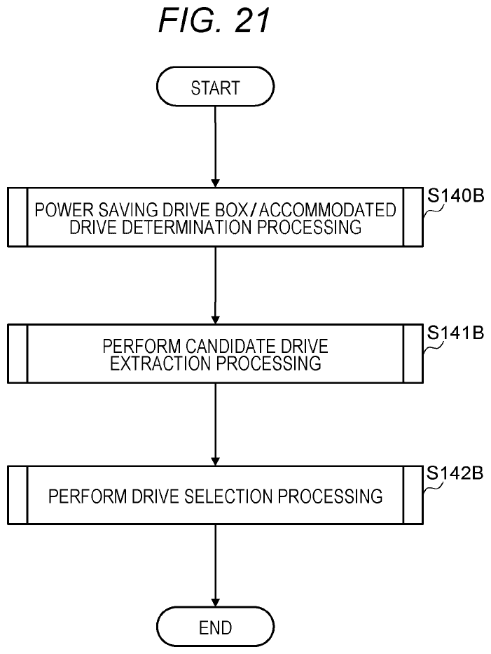

FIG. 21 is a flowchart illustrating drive group determination processing according to the second embodiment. The drive group determination processing according to the second embodiment is executed instead of the drive group determination processing (FIG. 13) according to the first embodiment.

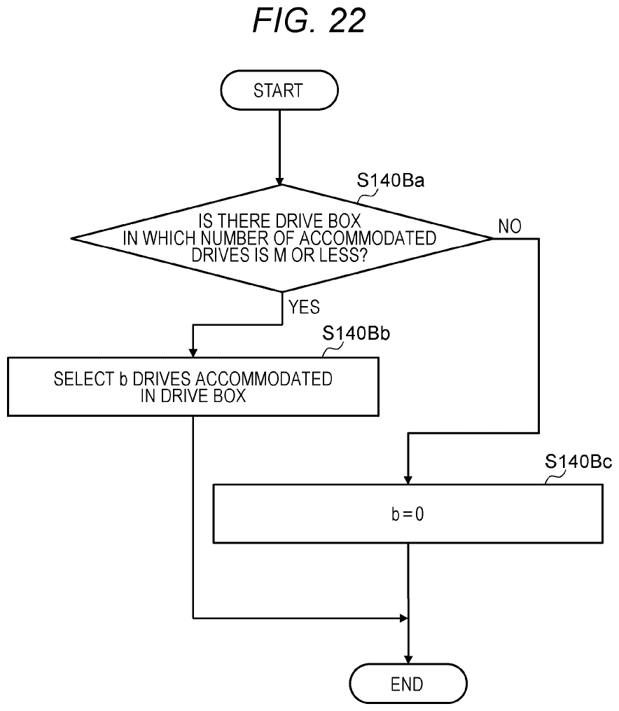

First, in step S140B, the drive power control unit 43 executes power saving drive box/accommodated drive determination processing. Details of the power saving drive box/accommodated drive determination processing will be described later with reference to FIG. 22.

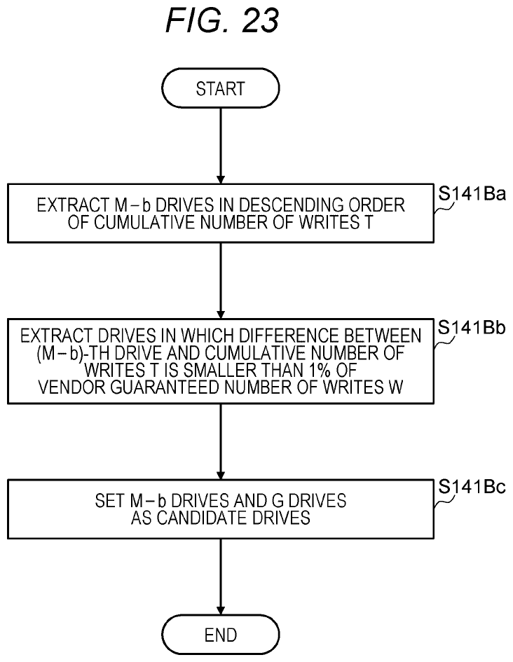

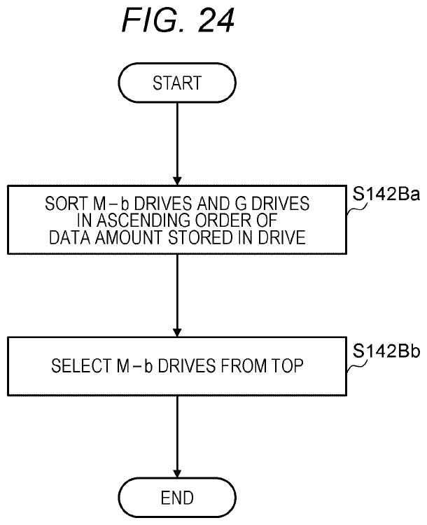

Next, in step S141B, the drive power control unit 43 executes candidate drive extraction processing. Details of the candidate drive extraction processing will be described later with reference to FIG. 23. Next, in step S142B, the drive power control unit 43 executes drive selection processing. Details of the drive selection processing will be described later with reference to FIG. 24.

### (Power Saving Drive Box/Accommodated Drive Determination Processing According to Second Embodiment)

FIG. 22 is a flowchart illustrating the power saving drive box/accommodated drive determination processing (step S140B (FIG. 21)) according to the second embodiment. In the power saving drive box/accommodated drive determination processing, all the drives 62 in a drive box 6 having M or less drives 62 (the number M is calculated in the number-of-power saving target drives calculation processing (step S13 (FIG. 7))) are set as power saving target drives and power supply is turned off. Furthermore, power supply to the power feeding function unit 61 of the drive box 6 is turned off to achieve further power saving.

First, in step S140Ba, the drive power control unit 43 determines whether there is a drive box 6 in which the number of accommodated drives 62 is M or less. If there is a drive box 6 in which the number of accommodated drives 62 is M or less (YES in step S140Ba), the drive power control unit 43 moves the processing to step S140Bb. On the other hand, if there is no drive box 6 in which the number of accommodated drives 62 is M or less (NO in step S140Ba), the drive power control unit 43 moves the processing to step S140Bc.

In step S140Bb, the drive power control unit 43 selects b drives 62 accommodated in the drive box 6 accommodating M or less drives 62 in step S140Ba. On the other hand, in step S140Bc, the drive power control unit 43 sets b=0.

### (Candidate Drive Extraction Processing According to Second Embodiment)

FIG. 23 is a flowchart illustrating the candidate drive extraction processing (step S141B (FIG. 21)) according to the second embodiment.

First, in step S141Ba, for a processing target drive box 6, the drive power control unit 43 extracts M−b drives 62 (the drive identification information 311) in descending order of the cumulative number-of-writes value T of the cumulative number of writes 319 from the drive information table 31. Here, the processing target drive box 6 is a drive box 6 in which it is determined in step S140Ba (FIG. 22) that the number of accommodated drives 62 is more than M.

Next, in step S141Bb, the drive power control unit 43 extracts drives 62 (the drive identification information 311) meeting a predetermined condition separately from the M−b drives 62. The predetermined condition is a condition that a difference between the minimum value of the cumulative number-of-writes values T of the M−b drives 62 extracted in step S141Ba and the cumulative number-of-writes value T is less than a predetermined % (1% or the like) of the vendor guaranteed number-of-writes value W of the vendor guaranteed number of writes 320. Here, it is assumed that G drives 62 are extracted.

Next, in step S141Bc, the drive power control unit 43 sets the M−b drives 62 extracted in step S141Ba and the G drives 62 extracted in step S141Bb as candidate drives.

### (Drive Selection Processing According to Second Embodiment)

FIG. 24 is a flowchart illustrating the drive selection processing (step S142B (FIG. 21)) according to the second embodiment.

First, in step S142Ba, the drive power control unit 43 sorts the M−b+G drives 62 extracted in step S141B (FIG. 21) in ascending order of the active data amount+the inactive data amount on the basis of the drive information table 31.

Next, in step S142Bb, the drive power control unit 43 selects M−b drives 62 in ascending order of the active data amount+the inactive data amount from the drives 62 sorted in step S142Ba.

Note that the M−b drives 62 selected in step S142Bb and the b drives 62 selected in step S140Bb (FIG. 22) are powered off in step S19 of the drive power-off processing (FIG. 7). In addition, the b drives 62 selected in step S140Bb are powered off in step S19 of the drive power-off processing, and the power feeding function unit 61 of the drive box 6 in which the b drives 62 are accommodated is also powered off.

### (Effects of Second Embodiment)

In the second embodiment, after power supply to the power saving target drive is turned off, power supply to a drive box in which all the accommodated drives are the power saving target drives among a plurality of drive boxes is turned off. Therefore, the drive box can be turned off in addition to the drives, and thus a further power saving effect can be achieved.

### Third Embodiment

In the first embodiment, the active data is aggregated into the normal drives, the inactive data is aggregated into the power saving target drives, and the power of the power saving target drives is turned off. On the other hand, in the third embodiment, the active data+the inactive data are aggregated into the normal drives, and the power of the power saving target drives is turned off as it is. In the following description of the third embodiment, differences from the first embodiment will be mainly described.

### (Drive Power-Off Processing According to Third Embodiment)

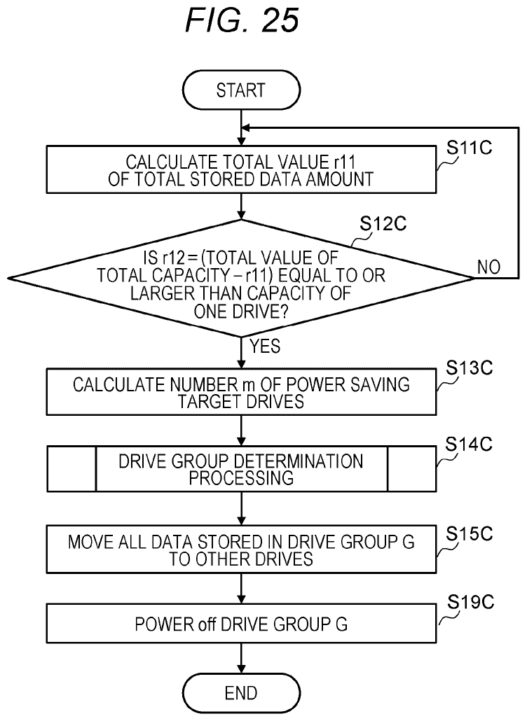

FIG. 25 is a flowchart illustrating drive power-off processing according to the third embodiment. The drive power-off processing according to the third embodiment is executed instead of the drive power-off processing (FIG. 7) according to the first embodiment. The drive power-off processing according to the third embodiment is periodically executed by the drive power control unit 43 in units of drive boxes 6.

First, in step S11C, the drive power control unit 43 refers to the RAID group information table 34, and calculates a total value r11 of the total stored data amount 346 of a RAID group in the processing target drive box 6.

Next, in step S12C, the drive power control unit 43 determines whether r12=(the total value of the total capacity of the RAID group in the processing target drive box 6−r11) is equal to or larger than the capacity of one drive 62. If r12 is equal to or larger than the capacity of one drive 62 (YES in step S12C), the drive power control unit 43 moves the processing to step S13C, and if r12 is smaller than the capacity of one drive 62 (NO in step S12C), the drive power control unit 43 returns the processing to step S11C.

Next, in step S13C, the drive power control unit 43 calculates a number m of power saving target drives in the processing target drive box 6. In step S13C, the drive power control unit 43 refers to the drive information table 31, and sets a value (rounded down to the nearest whole number) obtained by dividing r12 calculated in step S12C by the capacity value of the capacity 315 of one drive 62 as the number m of power saving target drives.

Next, in step S14C, the drive power control unit 43 executes drive group determination processing of selecting drives 62 corresponding to the number m calculated in step S13C in the processing target drive box 6 and determining the drive group G. The drive group determination processing here is processing in which the number “M” of drives 62 in the drive group selection processing (FIG. 13) according to the first embodiment is replaced with “m”.

Next, in step S15C, the drive power control unit 43 controls the data movement control unit 42 to move all the data stored in the drives 62 of the drive group G to the drives 62 other than the drive group G in the processing target drive box 6.

Next, in step S19C, the drive power control unit 43 turns off all the power of the drives 62 of the drive group G determined in step S14C.

### (Effects of Third Embodiment)

In the third embodiment, the normal drive and the power saving target drive are determined in units of drives, data is moved from the power saving target drive to the normal drive, and power supply to the power saving target drive is turned off. Therefore, unused areas distributed in the drives are aggregated into one or more drives, and the power is turned off in units of drives, so that it is possible to achieve a fine power saving effect according to the size of the unused area.

### Fourth Embodiment

In the third embodiment, the active data+the inactive data are aggregated into the normal drives in finer units of drives 62 for one RAID group, and the power of the power saving target drives is turned off. On the other hand, in a fourth embodiment, the active data+the inactive data are aggregated into the drives 62 constituting a normal RAID group among a plurality of pools (RAID groups). The power of the drives 62 constituting a power saving target RAID group constituting a pool (RAID group) storing no data is turned off.

That is, unused areas of the drives 62 distributed in the pools (RAID groups) are aggregated into one pool (RAID group), and the power of the power saving target drives constituting this pool is turned off.

Here, the normal RAID group is a RAID group in which the drives 62 constituting the RAID group are powered on or maintained powered on. The power saving target RAID group is a RAID group in which the drives 62 constituting the RAID group are powered off. In the following description of the fourth embodiment, differences from the third embodiment will be mainly described.

### (Drive Power-Off Processing According to Fourth Embodiment)

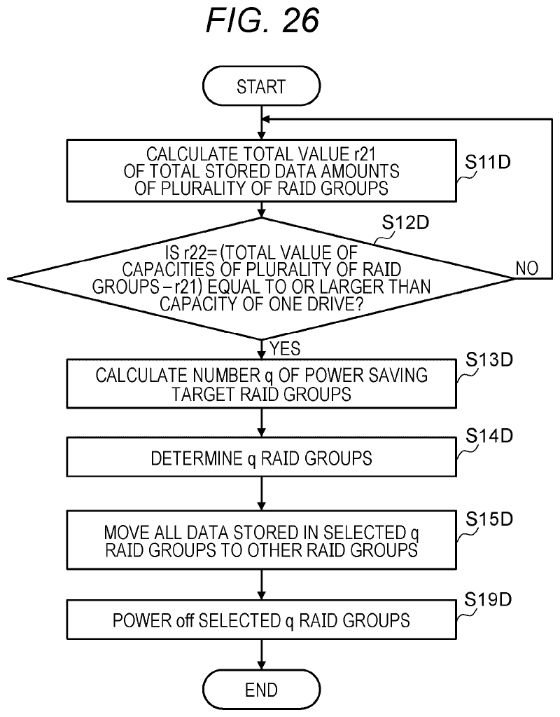

FIG. 26 is a flowchart illustrating drive power-off processing according to the fourth embodiment. The drive power-off processing according to the fourth embodiment is executed instead of the drive power-off processing (FIG. 25) according to the third embodiment. The drive power-off processing according to the fourth embodiment is periodically executed by the drive power control unit 43 for a plurality of processing target RAID groups.

First, in step S11D, the drive power control unit 43 refers to the RAID group information table 34, and calculates a total value r21 of the total stored data amounts of the plurality of processing target RAID groups.

Next, in step S12D, the drive power control unit 43 determines whether r22=(the total value of the capacities of the plurality of RAID groups−r21) is equal to or larger than the capacity of one drive 62. If r22 is equal to or larger than the capacity of one drive 62 (YES in step S12D), the drive power control unit 43 moves the processing to step S13D, and if r22 is smaller than the capacity of one drive 62 (NO in step S12D), the drive power control unit 43 returns the processing to step S11D.

Next, in step S13D, the drive power control unit 43 calculates a number q of power saving target RAID groups in the processing target drive box 6. In step S13D, the drive power control unit 43 refers to the RAID group information table 34, and sets a value (rounded down to the nearest whole number) obtained by dividing r22 calculated in step S12D by the total of the total capacities 345 of the plurality of RAID groups as the number q of power saving target RAID groups.

Next, in step S14D, the drive power control unit 43 executes RAID group group determination processing of selecting RAID groups corresponding to the number q calculated in step S13D and determining a RAID group group RG. In the RAID group group determination processing, the RAID group group RG is determined in ascending order of the total stored data amount 346.

Next, in step S15D, the drive power control unit 43 controls the data movement control unit 42 to move all the data stored in the drives 62 of the RAID group group RG to the drives 62 of the RAID groups other than the RAID group group RG.

Next, in step S19D, the drive power control unit 43 sets the RAID group group RG determined in step S14D as power saving target RAID groups, and turns off all the power of the drives 62 constituting the power saving target RAID groups.

### (Effects of Fourth Embodiment)

In the fourth embodiment, the normal drive and the power saving target drive are determined in units of pools (RAID groups), data is moved from the power saving target drive to the normal drive, and power supply to the power saving target drive is turned off. Therefore, unused areas distributed in the pools are aggregated into one pool, and the drives are powered off in units of pools, so that a large power saving effect can be achieved.

Although some embodiments have been described above, these are examples for describing the present invention, and it is not intended to limit the scope of the present invention only to these embodiments. The present invention can also be implemented in various other modes, for example, in a mode in which a part of the configuration of each of the above-described embodiments is deleted, in a mode in which at least a part of the configuration is replaced, in a mode in which a configuration is added, and in a mode in which a part or all of the embodiments are combined.

What is claimed is:

1. A storage system comprising: a plurality of drives accessed in response to an I/O request from a host; and a processor, wherein
the processor
determines a normal drive whose power supply is turned on and a power saving target drive whose power supply is turned off among the plurality of drives on a basis of a data amount stored in the plurality of drives,
moves all data stored in the power saving target drive to the normal drive, and
turns off power supply to the power saving target drive after all data stored in the power saving target drive is moved to the normal drive.

2. The storage system according to claim 1, wherein
the processor
manages a determination result obtained by determining whether each piece of data stored in the plurality of drives is active data accessed at a frequency equal to or higher than a certain frequency or inactive data accessed at a frequency lower than the certain frequency on a basis of a last access date and time related to the access to each piece of the data,
determines the normal drive and the power saving target drive on a basis of a data amount of the inactive data stored in the plurality of drives,
moves all the inactive data stored in the normal drive to the power saving target drive after all data stored in the power saving target drive is moved to the normal drive, and
turns off power supply to the power saving target drive after all the inactive data stored in the normal drive is moved to the power saving target drive.

3. The storage system according to claim 2, wherein
the processor
selects the power saving target drive from the plurality of drives on a basis of write performances of the drives.

4. The storage system according to claim 2, wherein
the processor
selects the power saving target drive from the plurality of drives on a basis of a life of each of the drives based on an actual number of writes of each of the drives and a number of writable times in product specifications.

5. The storage system according to claim 2, wherein
the processor
selects the power saving target drive from the plurality of drives in ascending order of a data amount of the inactive data stored in each of the drives.

6. The storage system according to claim 2, wherein
the processor
turns on power supply to the power saving target drive in a case where an I/O request from the host is made for the inactive data stored in the power saving target drive whose power supply is turned off,
accesses the inactive data after power supply to the power saving target drive is turned on, and
turns off power supply to the power saving target drive when the access to the inactive data ends.

7. The storage system according to claim 2, wherein
the processor
determines whether each piece of data stored in the plurality of drives is the active data or the inactive data at a predetermined cycle,
determines whether an increase amount of the inactive data determined this time relative to the inactive data determined last time exceeds a threshold value,
turns on power supply to the power saving target drive in a case where the increase amount exceeds the threshold value,
moves the inactive data corresponding to the increase amount from the normal drive to the power saving target drive after power supply to the power saving target drive is turned on, and
turns off power supply to the power saving target drive after the inactive data corresponding to the increase amount is moved from the normal drive to the power saving target drive.

8. The storage system according to claim 2, wherein
the processor
compares a number of drives of the power saving target drive with a number of unused drives in which no data is stored, and
cancels processing of determining the power saving target drive, processing of moving all data stored in the power saving target drive to the normal drive, processing of moving all the inactive data stored in the normal drive to the power saving target drive, and processing of turning off power supply to the power saving target drive in a case where the number of drives of the power saving target drive is smaller than the number of unused drives.

9. The storage system according to claim 2, wherein
the plurality of drives are accommodated in a plurality of drive boxes each accommodating a predetermined number of the drives, and
the processor
turns off power supply to the power saving target drive, and then turns off power supply to a drive box in which all the accommodated drives are the power saving target drives among the plurality of drive boxes.

10. The storage system according to claim 1, wherein
the processor
determines the normal drive and the power saving target drive in units of the drives on a basis of a data amount stored in the plurality of drives in units of the drives,
moves all data stored in the power saving target drive in units of the drives to the normal drive, and
turns off power supply to the power saving target drive after all data stored in the power saving target drive in units of the drives is moved to the normal drive.

11. The storage system according to claim 1, wherein
the processor
determines the normal drive and the power saving target drive in units of pools on a basis of a data amount stored in the plurality of drives in units of the pools,
moves all data stored in the power saving target drive in units of the pools to the normal drive, and
turns off power supply to the power saving target drive after all data stored in the power saving target drive in units of the pools is moved to the normal drive.

12. A power control method executed by a processor of a storage system including a plurality of drives accessed in response to an I/O request from a host and the processor, the power control method comprising:
determining a normal drive whose power supply is turned on and a power saving target drive whose power supply is turned off among the plurality of drives on a basis of a data amount stored in the plurality of drives;
moving all data stored in the power saving target drive to the normal drive; and
turning off power supply to the power saving target drive after all data stored in the power saving target drive is moved to the normal drive.
